(19) United States
(12) Patent Application Publication
(10) Pub. No.: US 2026/0119296 A1
(43) Pub. Date: Apr. 30, 2026

(54) PROCESSOR, HOST PROCESSOR AND METHOD OF OPERATING A PROCESSOR

(71) Applicant: Arm Limited, Cambridge (GB)

(72) Inventors: Quenton Michael JONES, St. Albans (GB); Daren CROXFORD, Swaffham Prior (GB)

(21) Appl. No.: 18/930,249

(22) Filed: Oct. 29, 2024

(51) Int. Cl. G06F 11/07; G06F 9/50

(52) U.S. Cl. CPC G06F 11/0772; G06F 9/5044; G06F 11/079

(57) ABSTRACT

A method of operating a processor having a permanent fault; the method including: receiving, at a controller, an indication that a permanent fault is detected in a processing unit of the processor; generating, by the controller and in response to the indication, a workload allocation scheme to allocate a workload among processing units in which no permanent fault is detected; instructing, by the controller, the processor to process the workload according to the workload allocation scheme. A host processor configured to execute a driver to allocate a workload among processing units of a subject processor in response to a permanent fault. A processor including a plurality of processing units and controller circuitry configured, responsive to an indication from fault detection circuitry, to communicate with fault detection circuitry and to allocate a workload among processing units of a subject processor.

### FIELD OF THE INVENTION

The present disclosure relates to a method of operating a processor comprising a plurality of processing units. In particular, the present disclosure relates to operating a processor having a permanent fault.

### BACKGROUND OF THE INVENTION

Processors, such as graphics processing units (GPUs), are used in a wide variety of safety critical situations. As an example, connected autonomous vehicles use GPUs to process data and make decisions relating to autonomous driving functionality.

Some processors may experience performance issues, for example, developing transient or permanent faults which may impact processing.

Existing mitigations address such performance issues by relying on redundancy, often by providing a redundant processor or processors.

The present techniques relate to efficient redundancy provision for processors.

### SUMMARY OF THE INVENTION

According to a first approach of present techniques, there is provided a method of operating a processor having a permanent fault; the method comprising: receiving, at a controller, an indication that a permanent fault is detected in a processing unit of the processor; generating, by the controller and in response to the indication, a workload allocation scheme to allocate a workload among processing units in which no permanent fault is detected; instructing, by the controller, the processor to process the workload according to the workload allocation scheme.

The method may be a computer-implemented method. The method may comprise providing a processor comprising a plurality of processing units.

The processor may be any processor comprising a plurality of processing units. For example, the processor may be a graphics processing unit, GPU. The processor may be any processor suitable for processing graphics.

A processing unit may be any part or component of the processor that is configured to process or assist with processing. The plurality of processing units of the processor may comprise any type of processing, or processing assisting, unit, of which the processor has a plurality. For example, the processing units may be partitions, shader slices, caches or shader cores. The plurality of processing units of the processor may be parallel processing units. Parallel processing units may be configured to operate in parallel, i.e., to each conduct processing substantially simultaneously.

The processing units of the processor may be configured to process a workload. For example, the workload may comprise a plurality of jobs configured to be distributed among the processing units for processing. Where the processing units are parallel processing units, a plurality of jobs may be processed in parallel, i.e., simultaneously, by the parallel processing units to execute the workload efficiently. In some cases, the processor may split a job into a plurality of tasks, i.e., portions of the job. The processor may distribute the tasks among processing units, e.g., shader cores, of the processor.

A permanent fault may be any fault that is not transient. For example, a permanent fault may be a fault that is not resolved within a predetermined time interval, e.g., a fault that is detected continuously throughout a predetermined time interval, or, in other words, at no point in the predetermined time interval is an absence of the fault detected. In practice, a permanent fault may be a fault that, once detected, is always detected. A permanent fault may be a hardware fault, e.g., a failed circuit device such as a failed transistor. A processor may develop permanent faults through normal use, i.e., aging or wear and tear. An expected rate of occurrence of permanent faults, or a mean time between failures, may be estimated for a specific processor.

In some embodiments, a permanent fault may be any fault that indicates a permanent problem within the processing unit, e.g., a fault that indicates that the processing unit is unreliable and should not be used. Such unreliability may be caused by a reduced processing speed, for example. In these cases, a permanent fault may not be detected continuously throughout a predetermined time interval but may instead be detected periodically throughout a predetermined time interval. For example, detection of a number of transient faults exceeding a predetermined threshold within a time period may qualify as a permanent fault in a processing unit.

In some embodiments, when any fault is detected, e.g., during a scheduled periodic test, it may be initially treated as a permanent fault and, in response, the controller may generate a workload allocation scheme and instruct the processor. Subsequent re-testing of the processing unit having the fault, e.g., as a background activity, may be used to confirm the status of the fault as permanent or not. For example, if the fault is not detected in a second test, the fault may be categorised as not permanent. In that case, the controller may generate a revised workload allocation scheme to re-allocate the workload among all processing units in which no permanent fault is detected. The controller may instruct the processor to process the workload according to the revised workload allocation scheme immediately, or at a convenient juncture in processing. Alternatively, if the fault is detected in the second test, the fault may be categorised as permanent and the instant workload allocation scheme may be maintained.

The controller may be integral to the processor, e.g. a microcontroller unit in the processor. Alternatively, the controller may be external to the processor, e.g., a driver executed by a host processor. The controller may be any suitable hardware or software entity configured to carry out the required steps of the method.

The workload allocation scheme may comprise data defining how a workload is to be allocated among processing units. The workload allocation scheme may define a division of a workload into a plurality of jobs. The workload allocation scheme may define an allocation of jobs among a plurality of processing units. The workload allocation scheme may comprise a set of instructions, e.g., associating each job of a workload with a specific processing unit. The instructions may be configured to be executed by a manager or frontend of the processor.

In use, when a processing unit of the processor suffers a permanent fault, the controller receives an indication of the fault, generates a workload allocation scheme excluding the processing unit comprising the fault, and instructs the processor to implement the workload allocation scheme to continue operating in the presence of the permanent fault.

In some implementations, the processor comprises a safety critical processor comprising a plurality of safety critical processing units.

A safety critical processor may be a processor configured to carry out safety critical processing. For example, a processor configured to process camera data in an adaptive cruise control system in a vehicle may be a safety critical processor. As another example, a processor configured to process data in an autonomous emergency braking system may be a safety critical processor. Such a processor may use machine learning to synthesise data from a plurality of sensors to decide whether to boost brake pedal effect or even apply the brakes without driver demand. Other advanced driver assistance systems may also include examples of safety critical machine learning processing.

In some implementations, receiving the indication that a permanent fault is detected in a processing unit of the processor comprises: receiving an indication that a permanent fault is detected; and receiving an indication of a location within the processor of the permanent fault.

In some implementations, the indication of the location within the processor comprises one or more selected from the list: partition identifier; shader slice identifier; cache identifier; shader core identifier. In some implementations, the cache identifier may identify an on-chip secondary cache.

In some implementations, receiving the indication that a permanent fault is detected in a processing unit of the processor comprises retrieving the indication from storage. The indication may be retrieved from memory. Alternatively, the indication may be retrieved from a register of the processor. For example, the indication may be retrieved from a status register of the processor.

In some implementations, the method further comprises detecting a permanent fault in a processing unit of the processor. In some cases, permanent faults may be detected by a built-in self-test (BIST) system, e.g., a logic BIST (LBIST), such that the processor may detect and report permanent faults to the controller itself. Alternatively, permanent faults may be detected by an external test system.

In some implementations, generating a workload allocation scheme to allocate a workload among processing units in which no permanent fault is detected comprises: evaluating a processing capacity of the processing units in which no permanent fault is detected; evaluating a processing requirement of the workload; determining whether the processing capacity is greater than the processing requirement; and in response to determining that the processing capacity is greater than the processing requirement, generating a workload allocation scheme to allocate an entirety of the workload among the processing units in which no permanent fault is detected; or in response to determining that the processing capacity is not greater than the processing requirement, generating a workload allocation scheme to allocate a portion of the workload among the processing units in which no permanent fault is detected.

Processing capacity may be a measure of how much processing the processor can perform in a given time period. Processing requirement may be a corresponding measure of how much processing the workload requires in the given time period. If processing requirement exceeds processing capacity, the processor is unable to complete the workload. In this case, the controller may generate a workload allocation scheme to define how a portion of the workload is to be allocated among the processing units.

In some implementations, generating a workload allocation scheme to allocate a portion of the workload among the processing units in which no permanent fault is detected comprises: identifying a high priority portion of the workload; evaluating a processing requirement of the high priority portion of the workload; determining whether the processing capacity is greater than the processing requirement of the high priority portion of the workload; in response to determining that the processing capacity is greater than the processing requirement, generating a workload allocation scheme to allocate an entirety of the high priority portion of the workload among the processing units in which no permanent fault is detected.

In some implementations, the high priority portion of the workload is a safety critical portion of the workload. So, if the processing capacity exceeds the processing requirement of the high priority portion of the workload, the processor may complete the safety critical portion of the workload.

In some implementations, identifying a high priority portion of the workload comprises: determining a job criticality indicator for each job of the workload; evaluating a processing requirement for each job of the workload; and excluding from the workload jobs having a job criticality indicator below a predetermined threshold criticality in descending order of processing requirement until the processing requirement of the workload falls below the processing capacity, or until no jobs having a job criticality indicator below the predetermined threshold criticality remain.

The job criticality indicator indicates a criticality of the job. For example, jobs relating to safety critical functions, e.g., displaying a speedometer of a vehicle, may have a high job criticality indicator, whereas jobs relating to less critical functions, e.g., displaying a splash screen on startup, may have a low job criticality indicator. As another example, video rendering to a dedicated infotainment system, e.g., an in-car entertainment system, may have a low job criticality indicator as this may be sacrificed in the event of a permanent fault so that high priority display or computer functions may be maintained.

Jobs having job criticality indicators over the predetermined threshold criticality are ineligible to be excluded from the workload. Jobs with job criticality indicators under the predetermined threshold criticality may be excluded from the workload. Of the excludable jobs, the jobs requiring the most processing may be excluded first such that the processing requirement of the remaining workload falls below the processing capacity after as few exclusion as possible.

By excluding jobs from the workload only until the processing capacity exceeds the processing requirement, a number of jobs excluded from the workload is minimised such that the high priority portion of the workload comprises as much of the workload as possible. In addition, an inefficient trial and error method of identifying the high priority portion of the workload is avoided.

In some implementations, identifying a high priority portion of the workload comprises: determining a job criticality indicator for each job of the workload; determining a job degradability indicator for each job having a job criticality indicator below the predetermined threshold criticality; evaluating a processing requirement for a degraded execution of each job of the workload having a job degradability indicator above a predetermined threshold degradability; evaluating a processing requirement for non-degraded execution each job of the workload having a job degradability indicator below the predetermined threshold degradability; and excluding from the workload jobs having a job criticality indicator below the predetermined threshold criticality in descending order of processing requirement until the processing requirement of the workload falls below the processing capacity, or until no jobs having a job criticality indicator below the predetermined threshold criticality remain.

The job degradability indicator indicates a degradability of the job. In other words, the job degradability indicator indicates whether it may be possible and acceptable to complete a degraded version of the job instead of the undegraded version of the job. A job that may be simplified without impact on its efficacy may have a high degradability indicator.

Further, a job that may be simplified without impact on vehicle safety may have a high degradability indicator. For example, some video rendering jobs, e.g., video rendering to a dedicated infotainment system, may have a high degradability indicator as it may be possible to degrade that job and it may be acceptable to complete a degraded version of the job as the job may be unrelated to safety critical systems of the vehicle. Degrading a video rendering job may include reducing the resolution of the video, e.g., from 1920×1080 pixels to 960×540 pixels, and/or reducing the frame rate of the video, e.g., from 60 frames per second to 30 frames per second. In this way, the job may be degraded such that it requires less processing to complete. There may be other video rendering jobs, e.g., rendering video of a rear view camera during reversing manoeuvres, that have lower degradability indicators as, although it may be possible to degrade those jobs, they may be relevant to vehicle safety so it may be deemed unacceptable to complete a degraded version of those jobs.

Jobs having job criticality indicators above the predetermined threshold criticality are ineligible to be degraded to reduce the processing requirement of the workload. So, only determining a job degradability indicator for each job having a job criticality indicator below the predetermined threshold criticality may save time and improve an efficiency of identification of the high priority portion of the workload.

Jobs having job degradability indicators under the predetermined threshold degradability are ineligible to be degraded to reduce the processing requirement of the workload. Jobs with job degradability indicators over the predetermined threshold may be degraded to reduce the workload. After the eligible jobs are degraded, the processing requirement of the degraded version of the job is considered in the identification of the high priority portion of the workload.

By degrading degradable jobs before excluding excludable job from the workload in order of processing requirement until the processing capacity exceeds the processing requirement, a number of jobs excluded from the workload is minimised such that the high priority portion of the workload comprises as much of the workload as possible. In addition, an inefficient trial and error method of identifying the high priority portion of the workload is avoided.

In some implementations, identifying a high priority portion of the workload comprises: determining a job criticality indicator for each job of the workload; determining a job degradability indicator for each job having a job criticality indicator below the predetermined threshold criticality; evaluating a processing requirement difference between a degraded execution and a non-degraded execution of each job of the workload having a job degradability indicator above the predetermined threshold degradability; evaluating a processing requirement for non-degraded execution each job of the workload; and degrading jobs having a job degradability indicator above the predetermined threshold degradability in descending order of processing requirement difference until the processing requirement of the workload falls below the processing capacity, or until no jobs having a job degradability indicator above the predetermined threshold degradability remain.

By degrading degradable jobs in order of processing requirement difference until the processing capacity exceeds the processing requirement, a number of jobs degraded is minimised such that the high priority portion of the workload comprises as many non-degraded jobs of the workload as possible.

If the processing requirement of the workload does not fall below the processing capacity before no jobs having a job degradability indicator above the predetermined threshold degradability remain, jobs having a job criticality indicator below a predetermined threshold criticality may be excluded from the workload in descending order of processing requirement until the processing requirement of the workload falls below the processing capacity, or until no jobs having a job criticality indicator below the predetermined threshold criticality remain as described above.

If the workload processing requirement cannot be reduced such that it falls below the processing capacity by any combination of the methods described above, the processor may be unable to perform the workload.

In some implementations, instructing the processor to process the workload according to the workload allocation scheme comprises writing the workload allocation scheme to storage. The workload allocation scheme may be written to memory. Alternatively, the workload allocation scheme may be written to a register of the processor. For example, the workload allocation scheme maybe written to a control register in the processor by a driver executing on a central processor.

In some implementations, a maximum utilisation of the processor required to process the workload is less than a predetermined threshold utilisation such that the processor is overprovisioned with processing capacity by at least the processing capacity of one processing unit.

The utilisation of the processor may be an amount of the capacity of the processor that is in use at a given time. Utilisation may be expressed as a percentage. The maximum utilisation of the processor required to process the workload may be the maximum amount of the capacity of the processor that is in use at a given time during the processing of the workload. In practice, the maximum utilisation may be estimated or measured.

A processor that is overprovisioned has more capacity than is required in normal use before a permanent fault occurs. By being overprovisioned by at least the processing capacity of one processing unit, the processor may tolerate a permanent fault causing the exclusion from the workload allocation scheme of one processing unit. Following any one permanent fault in a processing unit, the remaining processing capacity will be greater than or equal to the processing requirement so that processing can continue.

According to a further approach of present techniques, there is provided a processor configured to perform the method of the first approach of present techniques. There is also provided a host processor configured to execute a driver to allocate a workload among processing units of a subject processor, the driver being configured to perform the method of the first approach of present techniques.

According to a further approach of present techniques, there is provided a processor comprising a plurality of processing units and controller circuitry configured to: receive, from fault detection circuitry, an indication that a permanent fault is detected in a processing unit of the processor; generate at the controller circuitry, in response to the indication, a workload allocation scheme to allocate a workload among processing units in which no permanent fault is detected; and instruct the processing units to process the workload according to the workload allocation scheme.

The processor may be configured to be operated at a utilisation below a predetermined threshold utilisation such that the processor is overprovisioned with processing capacity by at least a processing capacity of one processing unit to enable the processor to continue processing after suffering a permanent fault. Before any permanent faults are detected, the processor may be configured to be operated at a utilisation below a predetermined threshold utilisation. After a permanent fault is detected, the processor may be configured to be operated at a utilisation above a predetermined threshold utilisation if necessary.

By being overprovisioned with processing capacity by at least the processing capacity of one processing unit, a permanent fault that causes a loss of processing capacity corresponding to the processing capacity of one processing unit may be tolerated. The processing capacity may comprise memory capacity such that the processor is overprovisioned with memory capacity to tolerate a permanent fault that causes a loss of memory capacity corresponding to one memory unit.

For example, for a processor comprising four processing units, the processing capacity of one processing unit is a quarter of the total processing capacity. So, to overprovision the processor with a quarter of its capacity, the processor may be operated at a utilisation (or duty cycle) below 75%, the predetermined threshold utilisation. In this way, during normal operation the four processing units operating at less than 75% utilisation process a workload having a processing requirement that is less than 300% of the utilisation of one processing unit. If a permanent fault is detected in one of the four processing units, the remaining three units may be utilised at less than 100% utilisation to process the same workload. Accordingly, as the utilisation of each processing unit required after the fault is less than 100%, the processor has capacity to continue processing after suffering one permanent fault.

In another example, for a processor comprising 16 shader slices, the predetermined threshold utilisation may be 93.75% such that the processor is overprovisioned to enable the processor to continue processing after suffering one permanent fault. In this way, overprovisioning the processor to enable it to tolerate a permanent fault may be highly efficient compared with the conventional alternative of providing an entire spare processor for use after a permanent fault.

In this approach, the controller circuitry is part of the processor. The controller circuitry may comprise a microcontroller unit disposed in a manager or frontend of the processor. The controller circuitry may receive the indication by retrieving the indication from a register, e.g., status register, of the processor. The controller circuitry may instruct the processing units by writing the workload allocation scheme to a register, e.g., control register, of the processor.

In some implementations, the controller circuitry is further configured to detect a permanent fault in a processing unit of the processor. For example, fault detection may be built into the processor and controlled by, or at least in communication with, the controller circuitry.

In some implementations, the indication that a permanent fault is detected in a processing unit of the processor comprises one or more selected from the list: partition identifier; shader slice identifier; cache identifier, shader core identifier. In this way, an identity of the partition, shader slice, cache or shader core in which the permanent fault has occurred is received by the controller circuitry. In this way, the controller circuitry may generate the workload allocation scheme excluding the partition, shader slice, cache or shader core in which the permanent fault has occurred. In other words, the controller circuitry may not allocate any jobs of the workload to the partition, shader slice, cache or shader core in which the permanent fault has occurred.

In some implementations, the controller circuitry is further configured to: evaluate a processing requirement of the workload; determine whether the processing capacity is greater than the processing requirement; and in response to determining that the processing capacity is greater than the processing requirement, generate, at the controller circuitry, a workload allocation scheme to allocate an entirety of the workload among the processing units in which no permanent fault is detected; or in response to determining that the processing capacity is not greater than the processing requirement, generate, at the controller circuitry, a workload allocation scheme to allocate a portion of the workload among the processing units in which no permanent fault is detected.

In some implementations, the processing units are arranged to operate in a parallel processing arrangement. For example, the processor may be a graphics processing unit, GPU.

According to a further approach of present techniques, there is provided a host processor configured to execute a driver to allocate a workload among processing units of a subject processor, the driver being configured to: retrieve, from storage, an indication that a permanent fault is detected in a processing unit of the subject processor; generate, in response to the indication, workload allocation scheme; wherein the workload allocation scheme is implementable by the subject processor to allocate a workload among processing units of the subject processor in which no permanent fault is detected; and write, to storage, the workload allocation scheme for implementation by the subject processor to process the workload despite presence of a permanent fault.

The host processor may be any suitable processor configured to perform the role of host, that is, managing and instructing the subject processor. For example, the host processor may comprise a central processing unit, CPU. The subject processor comprises a plurality of processing units configured to process the workload. For example, the subject processor may be a graphics processing unit, GPU.

In some implementations, the driver is further configured to: retrieve, from storage, utilisation data for the subject processor; and generate the workload allocation scheme in response to the indication and the utilisation data. For example, the host processor may, from the utilisation data, determine to what extent the subject processor is overprovisioned with processing capacity such that it may tolerate a permanent fault.

In some implementations, the utilisation data comprises at least one of: a predetermined threshold utilisation; an identity of a processing unit operating at a utilisation below the predetermined threshold utilisation; a difference between the utilisation of the processing unit and the predetermined threshold utilisation. In this way, the host processor may identify a processing unit that may be allocated more jobs of a workload should a permanent fault occur to trigger generation of a workload allocation scheme.

### BRIEF DESCRIPTION OF THE DRAWINGS

Embodiments of the present techniques will now be described by way of example only and with reference to the accompanying drawings, in which:

FIG. 1 is flowchart showing a method according to an approach of present techniques;

FIG. 2 is flowchart showing a further method according to an approach of present techniques;

FIG. 3 is flowchart showing a further method according to an approach of present techniques;

FIG. 4 is flowchart showing a further method according to an approach of present techniques;

FIG. 5 is flowchart showing a further method according to an approach of present techniques;

FIG. 6 is flowchart showing a method according to an approach of present techniques;

FIG. 7 is a schematic diagram showing a system comprising a host processor according to an approach of present techniques;

FIG. 8 is a schematic diagram showing a processor comprising a plurality of processing units according to an approach of present techniques;

FIG. 9 is a schematic diagram showing a further processor comprising a plurality of processing units according to an approach of present techniques; and

FIG. 10 is a schematic diagram showing a further processor comprising a plurality of processing units according to an approach of present techniques.

### DETAILED DESCRIPTION

Normally a processor cannot continue to operate after it has suffered a permanent hardware fault; the processor is failed. In general, the first permanent fault is unpredictable; where and when it will arise is not known. In many applications, particularly safety critical applications, such unpredictability is mitigated by provision of a large quantity of redundant resources so that at least some processing may continue after a permanent fault occurs.

For example, after suffering a permanent fault, modern highly autonomous vehicles must remain operational for at least the duration of the current drive-cycle (e.g., ˜1 day). Presently, this requirement is addressed by installing an entire reserve (or surplus) processor that is idle unless and until the primary processor fails.

Approaches according to present techniques exploit the modular architecture of processors to provide a processor that is able to tolerate one (or more) permanent faults. In this way, a need to provide redundant processors is reduced and efficiency is improved. In exchange for a modest increase in resources within one processor, provision of an entire redundant processor may be avoided.

A processor may have 16 identical processing units, where each processing unit is capable of independent processing and so is assigned to tasks according to dynamic changes in load. A permanent fault in any processing unit triggers a fault notification, indicating that the processing unit is failed. If the processor is overprovisioned by one (reserve) processing unit, i.e. normally operating at 15/16th of full capacity, then the processor may retain sufficient capacity to process a given workload after the failed processing unit is withdrawn from operation, or from a pool of available resources. In this way, the processor may continue in normal safe operation using remaining fault-free resources. As such, present techniques provide that the processor may continue operating despite the permanent fault.

Present techniques are particularly relevant to graphics processing units, GPUs, as those processors generally comprise highly modular parallelised architectures, dynamic control over modular resources and a great majority of the hardware (˜96%) within the modular components. As the non-modular components make up a very small proportion of the GPU hardware, a likelihood of common cause failure, i.e., a permanent fault occurring in the non-modular components, is relatively very small.

In some embodiments, a reserve resource may be substantially unused until the permanent fault occurs. In this way, an amount of reserve capacity may be substantially constant and simple to determine.

In other embodiments, the reserve resource may be in use when the permanent fault occurs. For example, before the permanent fault occurs, all the resources of the processor may be operating at a low utilisation, or duty cycle, such that the processor runs efficiently, i.e., generating less heat. Accordingly, by being overprovisioned, the processor is efficient before the permanent fault occurs. Moreover, in this way, the reserve resource is well tested and known to be operational when the permanent fault occurs and the reserve resource is needed. By contrast, setting aside 1/16th of the processor for use only after the permanent fault occurs runs a risk of that reserve resource being itself faulty or otherwise unsuitable when it is called to action.

In other embodiments, the reserve resource may be out of use, i.e., idle, when the permanent fault occurs but may have seen use before that time. For example, at any given time one reserve resource may be out of use, but the identity of that resource may change with each invocation of the processor such that each resource is the reserve resource in turn. In this way, a risk of the reserve resource being itself faulty when called upon in the event of a permanent fault is mitigated, while the amount of reserve capacity remains substantially constant and simple to determine.

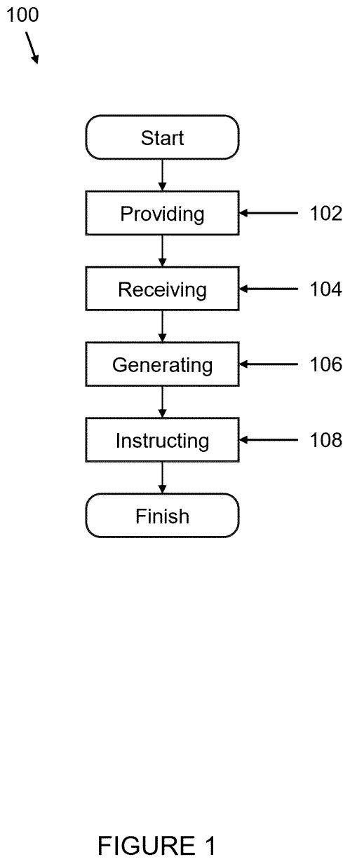

With reference to FIG. 1, there is illustrated a method 100 according to an approach of present techniques. The method 100 comprises, at optional step 102, providing a processor comprising a plurality of processing units. The method further comprises, at step 104, receiving, at a controller, an indication that a permanent fault is detected in a processing unit of the processor. The method further comprises, at step 106, generating, by the controller and in response to the indication, a workload allocation scheme to allocate a workload among processing units in which no permanent fault is detected. The method further comprises, at step 108, instructing, by the controller, the processor to process the workload according to the workload allocation scheme.

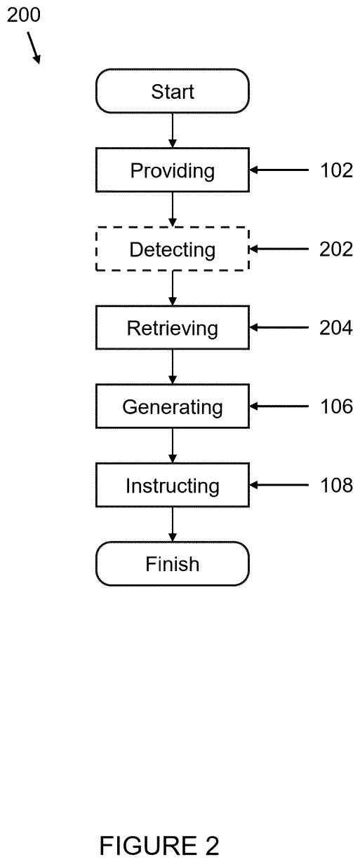

With reference to FIG. 2, there is illustrated a further method 200 according to an approach of present techniques. The method 200 of FIG. 2 shares some steps with the method 100 of FIG. 1, like reference numerals have been used for like steps. After providing a processor comprising a plurality of processing units at optional step 102, the method 200 comprises, at step 202, detecting a permanent fault in a processing unit of the processor. In FIG. 2, step 202 is shown in dashed lines to indicate that this step is optionally performed by the controller performing the following steps of retrieving 204, generating 106 and instructing 108.

In place of receiving an indication that a permanent fault is detected in a processing unit of the processor at step 104, the method 200 comprises, at step 204, retrieving the indication that a permanent fault is detected in a processing unit of the processor from storage.

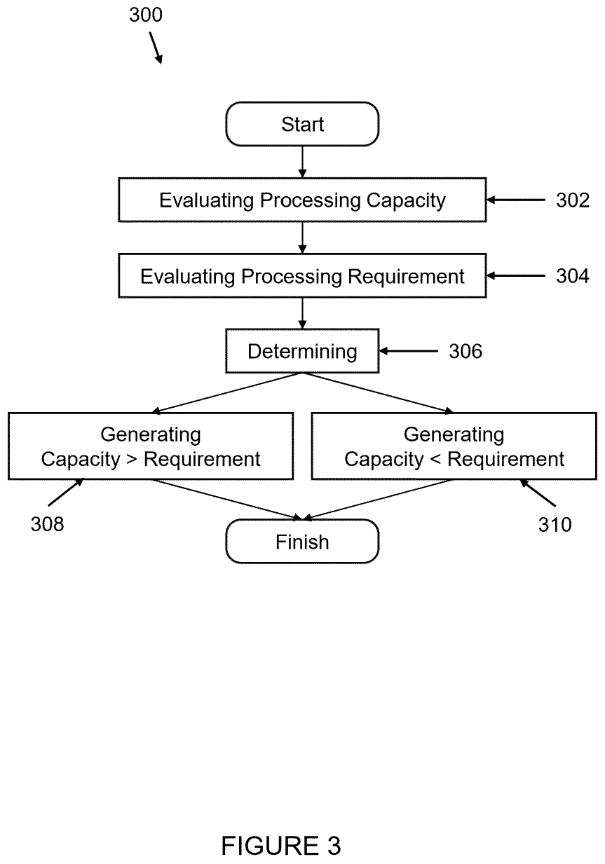

With reference to FIG. 3, there is illustrated a method 300 of generating a workload allocation scheme to allocate a workload among processing units in which no permanent fault is detected. The method 300 may correspond to step 106 of methods 100 and 200 discussed above.

The method 300 comprises, at step 302, evaluating a processing capacity of the processing units in which no permanent fault is detected. The method 300 further comprises, at step 304, evaluating a processing requirement of the workload. The method 300 further comprises, at step 306, determining whether the processing capacity is greater than the processing requirement. In response to determining that the processing capacity is greater than the processing requirement, the method 300 comprises, at step 308, generating a workload allocation scheme to allocate an entirety of the workload among the processing units in which no permanent fault is detected. Alternatively, in response to determining that the processing capacity is not greater than the processing requirement, the method 300 comprises, at step 310, generating a workload allocation scheme to allocate a portion of the workload among the processing units in which no permanent fault is detected.

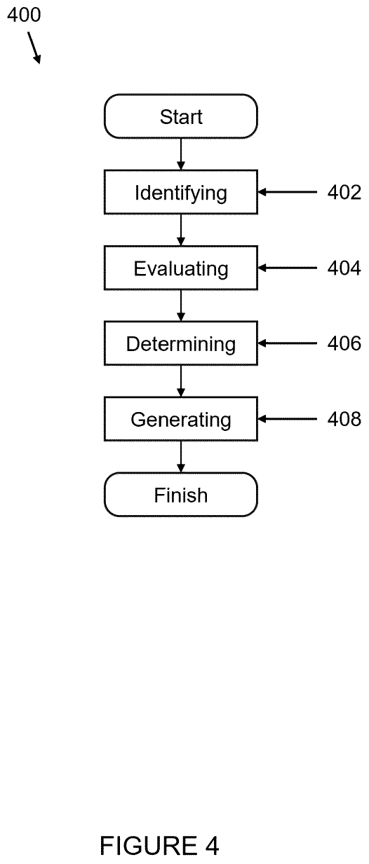

With reference to FIG. 4, there is illustrated a further method 400 of generating a workload allocation scheme to allocate a workload among processing units in which no permanent fault is detected. The method 400 may correspond to step 106 of methods 100 and 200 discussed above.

The method 400 comprises, at step 402, identifying a high priority portion of the workload. At step 404, the method 400 comprises evaluating a processing requirement of the high priority portion of the workload. The method 400 comprises, at step 406, determining whether the processing capacity is greater than the processing requirement of the high priority portion of the workload. Finally, in response to determining that the processing capacity is greater than the processing requirement, the method 400 comprises, at step 408, generating a workload allocation scheme to allocate an entirety of the high priority portion of the workload among the processing units in which no permanent fault is detected.

If, in the alternative, it is determined that the processing capacity is not greater than the processing requirement of the high priority portion of the workload, the processor may not have capacity to process the high priority portion of the workload. In this case, the processor may processor a further reduced and/or degraded portion of the workload, e.g., a portion of the high priority portion of the workload.

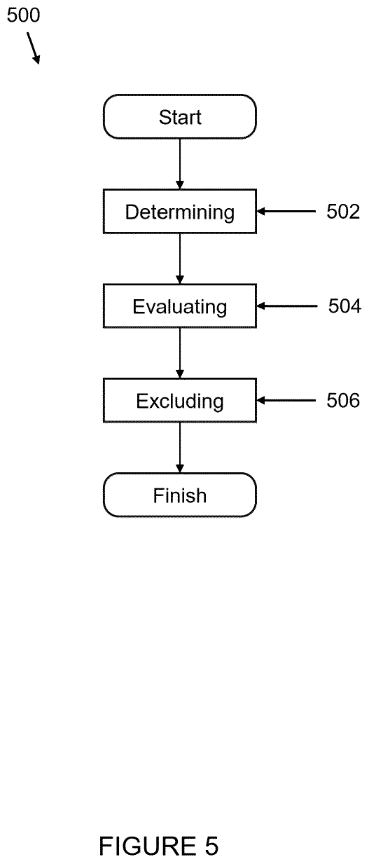

With reference to FIG. 5, there is illustrated a method 500 of identifying a high priority portion of the workload. The method 500 may correspond to step 402 of method 400 discussed above.

The method 500 comprises, at step 502, determining a job criticality indicator for each job of the workload. Next, the method 500 comprises, at step 504, evaluating a processing requirement for each job of the workload. Finally, the method 500 comprises, at step 506, excluding from the workload jobs having a job criticality indicator below a predetermined threshold criticality in descending order of processing requirement until the processing requirement of the workload falls below the processing capacity, or until no jobs having a job criticality indicator below the predetermined threshold criticality remain.

If, in the alternative, all jobs having a job criticality indicator below the predetermined threshold criticality are excluded before the processing requirement of the workload falls below the processing capacity, the processor may not have capacity to process the high priority portion of the workload. In this case, the processor may process a further reduced and/or degraded portion of the workload, e.g., a portion of the high priority portion of the workload.

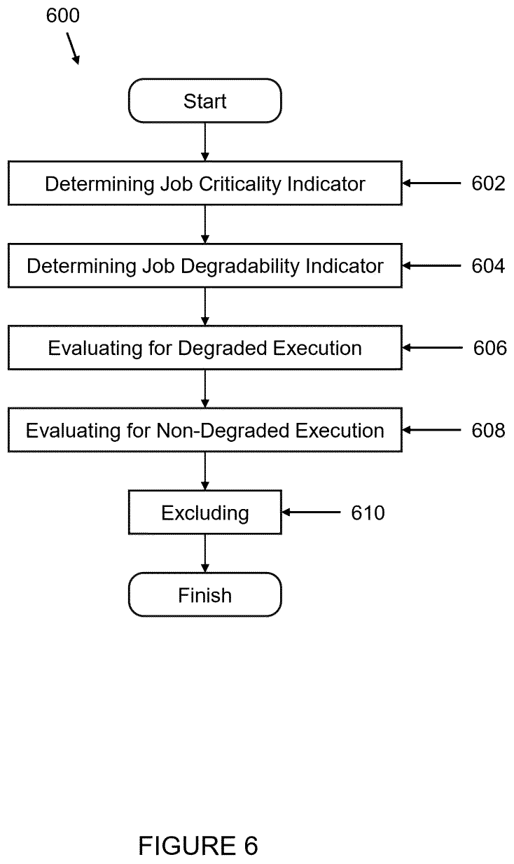

With reference to FIG. 6, there is illustrated a method 600 of identifying a high priority portion of the workload. The method 600 may correspond to step 402 of method 400 discussed above.

The method 600 comprises, at step 602, determining a job criticality indicator for each job of the workload and, at step 604, determining a job degradability indicator for each job having a job criticality indicator below the predetermined threshold criticality. The method 600 may further comprise, at step 606, evaluating a processing requirement for a degraded execution of each job of the workload having a job degradability indicator above a predetermined threshold degradability and, at step 608, evaluating a processing requirement for non-degraded execution each job of the workload having a job degradability indicator below the predetermined threshold degradability. Finally, the method 600 comprises, at step 610, excluding from the workload jobs having a job criticality indicator below the predetermined threshold criticality in descending order of processing requirement until the processing requirement of the workload falls below the processing capacity, or until no jobs having a job criticality indicator below the predetermined threshold criticality remain.

If, in the alternative, all jobs having a job criticality indicator below the predetermined threshold criticality are excluded before the processing requirement of the workload falls below the processing capacity, the processor may not have capacity to process the high priority portion of the workload. In this case, the processor may processor a further reduced and/or degraded portion of the workload, e.g., a portion of the high priority portion of the workload.

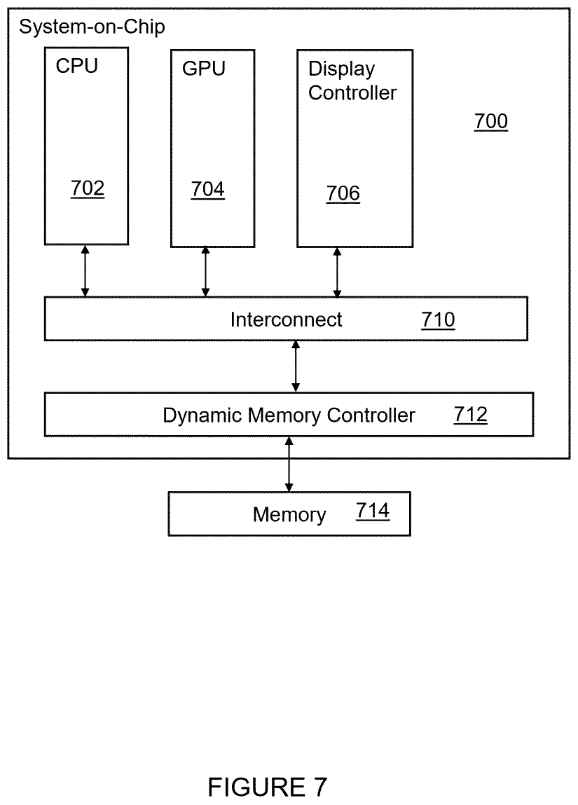

With reference to FIG. 7, there is illustrated a system 700 comprising a host processor (central processing unit, CPU) 702 according to an approach of present techniques. The system 700 also comprises a subject processor (graphics processing unit, GPU) 704, a display controller 706, an interconnect 710 and a dynamic memory controller (DMC) 712. The system 700 is in communication with a memory (storage) system 714 disposed outside the system 700. The CPU 702, GPU 704 and display controller 706 are configured to communicate with one another via the interconnect 710. The components of the system 700 are configured to read and write to memory 714 via the DMC 712.

The host processor 702 of FIG. 7 is configured to execute a driver to allocate a workload among processing units of a subject processor 704. The driver is configured to: retrieve, from storage 714, an indication that a permanent fault is detected in a processing unit of the subject processor 704. The driver is configured to generate, in response to the indication, a workload allocation scheme. The workload allocation scheme is implementable by the subject processor 704 to allocate a workload among processing units of the subject processor 704 in which no permanent fault is detected. The driver is configured to write, to storage 714, the workload allocation scheme for implementation by the subject processor 704 to process the workload despite presence of a permanent fault.

The driver of the host processor 702 may be further configured to retrieve, from storage 714, utilisation data for the subject processor 704. The driver may be configured to generate the workload allocation scheme in response to the indication and the utilisation data. Storage 714 may also store data structures, programs, instructions etc.

The subject processor 704 is configured to read, from storage 714, the workload allocation scheme. The command stream frontend of the subject processor 704 may issue jobs of the workload to processing units, e.g., shader cores, of the subject processor 704 for processing.

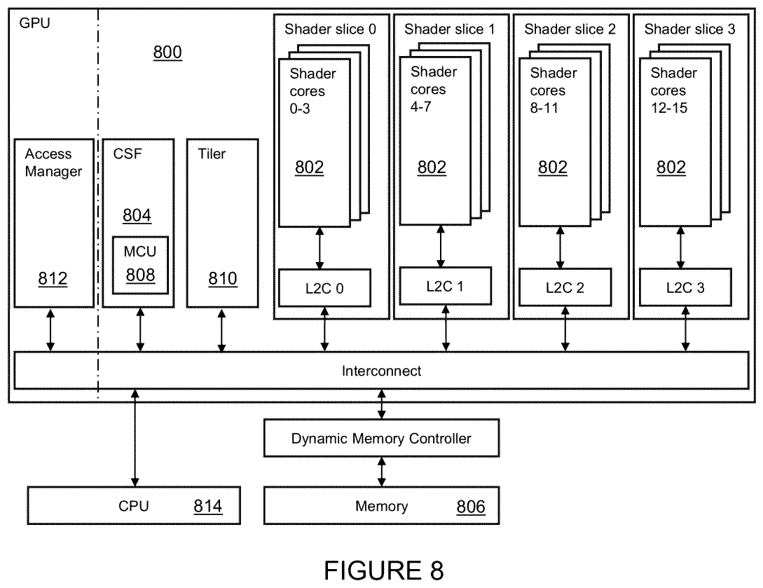

With reference to FIG. 8, there is illustrated a processor 800 comprising a plurality of processing units 802 according to an approach of present techniques. In FIG. 8, the processor 800 is a graphics processing unit, GPU. In FIG. 8, the processing units 802 are parallel processing units, specifically groups of shader cores called shader slices, each comprising four shader cores. Each shader slice 802 also comprises an on-chip secondary cache, L2C.

Each shader core may comprise a number of units, such as an Execution Engine (EE) configured to execute programs, a Texture Mapper (TM) which performs texture mapping, and a Neural Engine (NE) configured to process machine learning workloads. Where the GPU 800 is a tile based deferred GPU, there will be a tiler 810 which is configured to divide up geometry into 2D screen space portions, or tiles.

The GPU 800 comprises a command stream frontend (CSF) 804. According to some approaches, the CSF 804 is configured to read a command stream comprising the workload allocation scheme from memory 806, or from internal memory of the CSF, and issue jobs of the workload to the shader cores 802 according to the workload allocation scheme. The workload allocation scheme may have been generated by a host processor, or CPU, 814.

According to other approaches, the CSF 804 may contain a central processing unit or a microcontroller unit, MCU, 808. The MCU 808 may receive an indication that a permanent fault is detected in a processing unit 802 of the processor 800. The MCU 808 may next generate, in response to the indication, a workload allocation scheme to allocate a workload among processing units 802 in which no permanent fault is detected. Then, the MCU 808 may instruct the processing units 802 to process the workload according to the workload allocation scheme.

The processor 800 is configured to be operated at a utilisation below a predetermined threshold utilisation such that the processor 800 is overprovisioned with processing capacity by at least a processing capacity of one processing unit 802 to enable the processor to continue processing after suffering a permanent fault.

The processor 800 further comprises an access manager 812. The access manager 812 is an optional component of the processor 800. In some embodiments, the access manager 812 may perform some of the actions of the CSF 804, e.g., to retrieve from memory 806, or internal storage, the workload allocation scheme.

The GPU 800 may comprise Logic Built-In Self-Test (LBIST) which is configured to detect permanent faults in the processing units 802 of the processor. Testing may be performed when the GPU 800 is powered up, i.e., once per session, or may be performed periodically throughout normal operation of the GPU 800. If a permanent fault is detected in a processing unit 802, the access manager may alert the MCU 808 and/or the host processor 814.

In FIG. 8, there is one access manager 812, one CSF 804, one tiler 810. By contrast, there are four shader slices, four L2Cs and sixteen shader cores, together making up the processing units 802. The processing units 802 comprises the vast majority of the logic in the GPU 800 (e.g., >95%). As failure rate is proportional to an amount of logic, it is therefore many times more likely that a permanent fault will occur in the processing units 802 than in the components of the design that are only instanced once, i.e., access manager 812, CSF 804, and tiler 810.

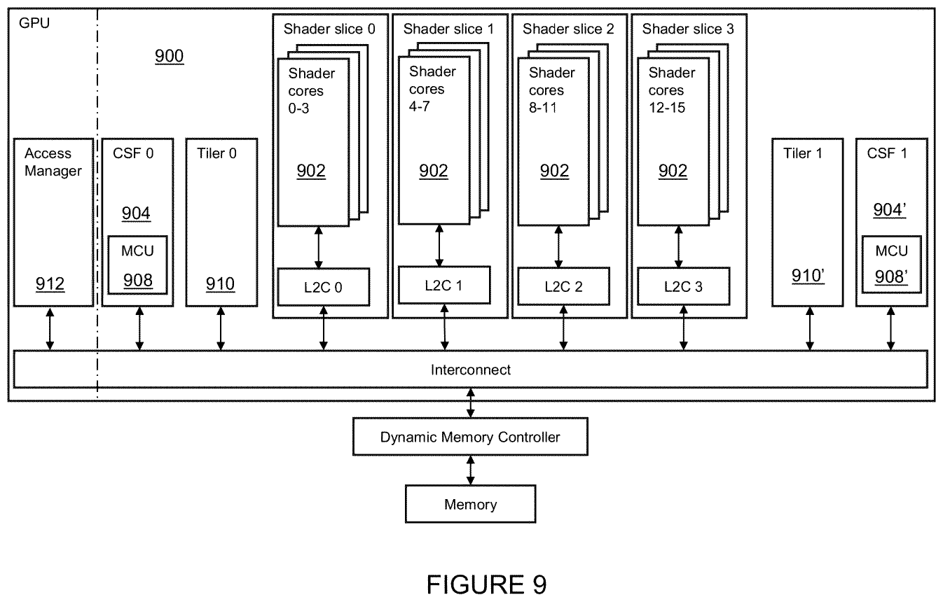

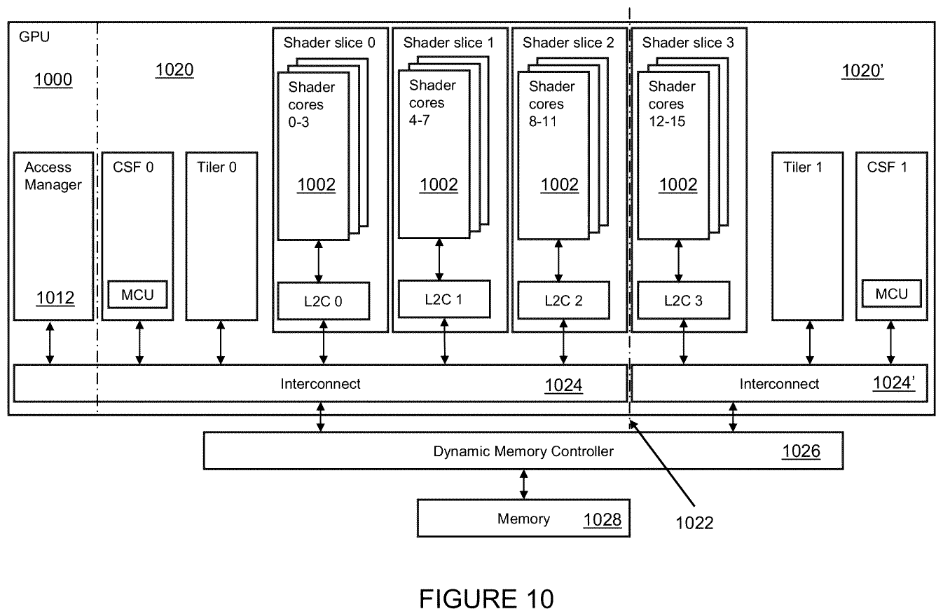

With reference to FIG. 9, there is illustrated a processor 900 comprising a plurality of processing units 902 according to an approach of present techniques. The processor 900 is a GPU that supports partitioning. In other words, the GPU 900 comprises multiple instances of certain components to enable the GPU to be partitioned into at least two independent partitions. In this case, the GPU 900 comprises two CSFs 904, 904′, each comprising an MCU 908, 908′ and two tilers 910, 910′. In this way, the processing units 902 may be split into two partitions, one managed by the first CSF 904 and tiler 910 and the other managed by the second CSG 904′ and tiler 910′. The GPU 900 may be divided into partitions by the access manager 912, as shown in FIG. 10. As such, the access manager is independent of the partitions and only one access manager 912 is required for the GPU 900.

With reference to FIG. 10, there is illustrated a processor 1000 comprising a plurality of processing units 1002 according to an approach of present techniques. The access manager 1012 has divided the GPU 1000 into two partitions, 1020, 1020′, along line 1022. The first partition 1020 may execute a first set of jobs while the second partition 1020′ may execute a second set of jobs. One of the first and second set of jobs may be safety critical while the other is not. In this way, the safety critical portion of the workload may be processed by a dedicated subset of the processing units 1002, separately from the rest of the workload.

When the partition is formed, the interconnect may be split into two interconnects 1024, 1024′ to support the separate partitions. Both interconnects 1024, 1024′ may be connected to the DMC 1026 to access memory 1028.

As will be appreciated by one skilled in the art, the present technology may be embodied as a method, a circuit or a computer readable medium comprising data and imperatives to cause construction of a circuit. Accordingly, the present technique may take the form of an entirely hardware embodiment, an entirely software embodiment, or an embodiment combining software and hardware. Where the word “component” is used, it will be understood by one of ordinary skill in the art to refer to any portion of any of the above embodiments.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define an HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and System Verilog or other behavioural representations of the concepts that can be interpreted by a computer to enable simulation, functional and/or formal verification, and testing of the concepts.

Additionally, or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively, or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively, or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In the present application, the words “configured to.” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

Accordingly, there has herein been described a method of operating a processor having a permanent fault; the method comprising: receiving, at a controller, an indication that a permanent fault is detected in a processing unit of the processor; generating, by the controller and in response to the indication, a workload allocation scheme to allocate a workload among processing units in which no permanent fault is detected; instructing, by the controller, the processor to process the workload according to the workload allocation scheme. There is also described a host processor configured to execute a driver to allocate a workload among processing units of a subject processor in response to a permanent fault. There is also described a processor comprising a plurality of processing units and controller circuitry configured, responsive to an indication from fault detection circuitry, to communicate with fault detection circuitry and to allocate a workload among processing units of a subject processor.

1. A method of operating a processor having a permanent fault, the method comprising:
receiving, at a controller, an indication that a permanent fault is detected in a processing unit of the processor;
generating, by the controller and in response to the indication, a workload allocation scheme to allocate a workload among processing units in which no permanent fault is detected;
instructing, by the controller, the processor to process the workload according to the workload allocation scheme; and
continuing to operate the processor with the allocated workload.

2. The method of claim 1, wherein the processor comprises a safety critical processor comprising a plurality of safety critical processing units.

3. The method of claim 1, wherein receiving the indication that a permanent fault is detected in a processing unit of the processor comprises:
receiving an indication that a permanent fault is detected; and
receiving an indication of a location within the processor of the permanent fault.

4. The method of claim 3, wherein the indication of the location within the processor comprises one or more selected from the list: partition identifier; shader slice identifier; cache identifier, shader core identifier.

5. The method of claim 1, wherein receiving the indication that a permanent fault is detected in a processing unit of the processor comprises retrieving the indication from storage.

6. The method of claim 1, further comprising detecting a permanent fault in a processing unit of the processor.

7. The method of claim 1, wherein generating a workload allocation scheme to allocate a workload among processing units in which no permanent fault is detected comprises:
evaluating a processing capacity of the processing units in which no permanent fault is detected;
evaluating a processing requirement of the workload;
determining whether the processing capacity is greater than the processing requirement; and
in response to determining that the processing capacity is greater than the processing requirement, generating a workload allocation scheme to allocate an entirety of the workload among the processing units in which no permanent fault is detected; or
in response to determining that the processing capacity is not greater than the processing requirement, generating a workload allocation scheme to allocate a portion of the workload among the processing units in which no permanent fault is detected.

8. The method of claim 7, wherein generating a workload allocation scheme to allocate a portion of the workload among the processing units in which no permanent fault is detected comprises:
identifying a high priority portion of the workload;
evaluating a processing requirement of the high priority portion of the workload;
determining whether the processing capacity is greater than the processing requirement of the high priority portion of the workload;
in response to determining that the processing capacity is greater than the processing requirement of the high priority portion of the workload, generating a workload allocation scheme to allocate an entirety of the high priority portion of the workload among the processing units in which no permanent fault is detected.

9. The method of claim 8, wherein the high priority portion of the workload is a safety critical portion of the workload.

10. The method of claim 8, wherein identifying a high priority portion of the workload comprises:
determining a job criticality indicator for each job of the workload;
evaluating a processing requirement for each job of the workload; and
excluding from the workload jobs having a job criticality indicator below a predetermined threshold criticality in descending order of processing requirement until the processing requirement of the workload falls below the processing capacity, or until no jobs having a job criticality indicator below the predetermined threshold criticality remain.

11. The method of claim 8, wherein identifying a high priority portion of the workload comprises:
determining a job criticality indicator for each job of the workload;
determining a job degradability indicator for each job having a job criticality indicator below the predetermined threshold criticality;
evaluating a processing requirement for a degraded execution of each job of the workload having a job degradability indicator above a predetermined threshold degradability;
evaluating a processing requirement for non-degraded execution of each job of the workload having a job degradability indicator below the predetermined threshold degradability; and
excluding from the workload jobs having a job criticality indicator below the predetermined threshold criticality in descending order of processing requirement until the processing requirement of the workload falls below the processing capacity, or until no jobs having a job criticality indicator below the predetermined threshold criticality remain.

12. The method of claim 1, wherein instructing the processor to process the workload according to the workload allocation scheme comprises writing the workload allocation scheme to storage.

13. The method of claim 1, wherein a maximum utilization of the processor required to process the workload is less than a predetermined threshold utilization to overprovision the processor with processing capacity by at least a processing capacity of one processing unit.

14. A processor comprising a plurality of processing units and controller circuitry configured to:
receive, from fault detection circuitry, an indication that a permanent fault is detected in a processing unit of the processor;
generate at the controller circuitry, in response to the indication, a workload allocation scheme to allocate a workload among processing units in which no permanent fault is detected;
instruct the processing units to process the workload according to the workload allocation scheme; and
continue to operate the processor with the allocated workload.

15. The processor of claim 14, wherein the indication that a permanent fault is detected in a processing unit of the processor comprises one or more selected from the list:
partition identifier; shader slice identifier; shader core identifier.

16. The processor of claim 14, wherein the controller circuitry is further configured to:
evaluate a processing requirement of the workload;
determine whether a processing capacity of the processing units in which no permanent fault is detected is greater than the processing requirement; and
in response to determining that the processing capacity of the processing units in which no permanent fault is detected is greater than the processing requirement, generate, at the controller circuitry, a workload allocation scheme to allocate an entirety of the workload among the processing units in which no permanent fault is detected; or
in response to determining that the processing capacity of the processing units in which no permanent fault is detected is not greater than the processing requirement, generate, at the controller circuitry, a workload allocation scheme to allocate a portion of the workload among the processing units in which no permanent fault is detected.

17. The processor of claim 14, wherein the processing units are arranged to operate in a parallel processing arrangement.

18. A host processor configured to execute a driver to allocate a workload among processing units of a subject processor, the driver being configured to:
retrieve, from storage, an indication that a permanent fault is detected in a processing unit of the subject processor;
generate, in response to the indication, a workload allocation scheme,
wherein the workload allocation scheme is implementable by the subject processor to allocate a workload among processing units of the subject processor in which no permanent fault is detected;
write, to storage, the workload allocation scheme for implementation by the subject processor to process the workload despite presence of a permanent fault; and
continue to operate the processor with the allocated workload.

19. The host processor of claim 18, wherein the driver is further configured to:
retrieve, from storage, utilization data for the subject processor; and
generate the workload allocation scheme in response to the indication and the utilization data.

20. The host processor of claim 19, wherein the utilization data comprises at least one of:
a predetermined threshold utilization;
an identity of a processing unit operating at a utilization below the predetermined threshold utilization;
a difference between the utilization of the processing unit and the predetermined threshold utilization.
